SEQUENCE LISTING (5 sequences)

SEQ ID NO: 1 - DNA, 27 bp, Artificial Sequence
  Synthetic Construct
tatgaattcaatccgtcgagcagagtt

SEQ ID NO: 2 - DNA, 27 bp, Artificial Sequence
  Synthetic Construct
attaatacgactcactatagggcgatg

SEQ ID NO: 3 - DNA, 11 bp, Artificial Sequence
  Synthetic Construct
ctatctcagtc

SEQ ID NO: 4 - DNA, 11 bp, Artificial Sequence
  Synthetic Construct
gatatagtcag

SEQ ID NO: 5 - DNA, 11 bp, Artificial Sequence
  Synthetic Construct
ctatatcagtc

(19) United States
(12) Patent Application Publication
(10) Pub. No.: US 2009/0093375 A1
(43) Pub. Date: Apr. 9, 2009

(54) DNA or RNA detection and/or quantification using spectroscopic shifts or two or more optical cavities

(76) Inventors: Stephen Arnold, New York, NY (US); Iwao Teraoka, Rye, NY (US); Frank Vollmer, New York, NY (US)

Correspondence Address: STRAUB & POKOTYLO, 788 Shrewsbury Avenue, TINTON FALLS, NJ, 07724, US

(21) Appl. No.: 10/768,977

(22) Filed: Jan. 30, 2004

Related U.S. Application Data
(60) Provisional application No. 60/443,736, filed on Jan. 30, 2003.

(51) Int. Cl. C40B 30/10; C40B 60/12

(52) U.S. Cl. 506/12; 506/39

(57) ABSTRACT

A spectroscopic technique for high-sensitivity, label free DNA quantification uses a shift in an optical resonance (whispering gallery mode, WGM) excited in a micron-sized optical cavity (e.g., a silica sphere) to detect and measure nucleic acids. The surface of the silica sphere is chemically modified with oligonucleotides. Hybridization to the target DNA leads to a red-shift of the optical resonance wavelength. The sensitivity of this resonance technique is higher than most optical single-pass devices such as surface plasmon resonance biosensors. Each microsphere can be identified by its unique resonance wavelength. Specific, multiplexed DNA detection may be provided by using two or more microspheres. The multiplexed signal from two or more microspheres illustrates that a single nucleotide mismatch in an 11-mer oligonucleotide can be discriminated with a high signal-to-noise of 54. This all-photonic WGM biosensor can be integrated on a chip, such as a semiconductor chip, which makes it an easy to manufacture, analytic component for a portable, robust lab-on-a-chip device.

### § 0.1 RELATED APPLICATIONS

This application claims benefit to U.S. Provisional Application Ser. No. 60/443,736 titled “PERTURBATION OF OPTICAL CAVITIES BY DNA HYBRIDIZATION,” filed on Jan. 30, 2003, and listing Stephan Arnold, Iwao Teraoka and Frank Vollmer as inventors (referred to as “the '736 provisional”). That application is incorporated herein by reference. The scope of the present invention is not limited to any requirements of the specific embodiments described in that application.

### § 0.2 FEDERAL FUNDING

This invention was made with Government support and the Government may have certain rights in the invention as provided for by grant number BES0119273 by the National Science Foundation.

### § 1. BACKGROUND OF THE INVENTION

§ 1.1. Field of the Invention

The present invention concerns DNA and RNA analysis. In particular, the present invention concerns detecting and/or quantifying DNA or RNA.

§ 1.2. Background Information

Genetic analysis has many important applications, such as medical diagnostics, food testing, forensic sciences and environmental monitoring for example. Generally, an oligonucleotide array (e.g., a short (normally 2-50 nucleotides) sequence of (usually single stranded) DNA which has been chemically synthesized for a specific experimental purpose) is used as a primer or probe for its sequence complement in a complex mixture of DNA. More specifically, DNA or RNA will hybridize with DNA or RNA having a complementary sequence of nucleotides. Hybridization occurs when two matching strands of DNA are held together by hydrogen bonds—adenine (A) to thamimine (T), or guanine (G) to cytosine (C). Similarly DNA and its complementary RNA can be held together by hydrogen bonds—adenine (A) to uracil (U), or G to C.

Recently traditional labor-intensive biochemical methods of detecting and/or quantifying DNA have been replaced with automated nucleic acid analysis techniques. However, further miniaturization and integration of DNA/RNA analysis techniques into portable, robust and easy to manufacture form (often referred to as “lab-on-a-chip” or “micro total analysis systems”) is desired.

Current DNA analysis methods can be classified as label-based and label-free techniques. Perceived limitations of these current DNA analysis methods are introduced below.

Labels are molecules which can be bound to complementary DNA and subsequently detected. Fluorescent labels are often used in current DNA analysis methods.

Gene chips using oligonucleotide arrays permit high-throughput DNA screening. Although already commercialized, gene chips still faces important challenges. Specifically, gene chips rely on labeling the target, using fluorescent labels for example. Unfortunately, however, target labeling can change the relative levels of targets originally present. Further, the acquisition and analysis of a fluorescent image corresponding to the fluorescently labeled targets is technically involved and may therefore preclude the use of such DNA chip technology as an analytic part of a small, portable and robust lab-on-a-chip device.

Biosensors used for label-free DNA detection are often based on optical methods (See, e.g., Baird, C. L., Myszka, D. G., “Current and emerging commercial optical biosensors,” Journal of Molecular Recognition, Vol. 14, pp. 261-268 (2001); and Rich, R. L., Myszka, D. G., “Survey of the year 2001 commercial optical biosensor literature,” Journal of Molecular Recognition, Vol. 15, pp. 352-376 (2002).) such as highly sensitive interferometric devices (See, e.g., Lin, V. S.-Y., Motesharei, K., Dancil, K.-P. S., Sailor, M. J., Ghadiri, M. R., “A Porous Silicon-Based Optical Interferometric Biosensor,” Science, Vol. 278, pp. 840-843 (1997).) and surface plasmon resonance (SPR) sensors (SPR) which are the most prominent ones (See, e.g., Bates P. J., Reddoch J. F., Hansakul P., Arrow A., Dale R., Miller D. M., “Biosensor detection of triplex formation by modified oligonucleotides,” Analytical Biochemistry, Vol. 307, pp. 235-243 (2002); Bianchi N., Rutigliano C., Tomassetti M., Feriotto G., Zorzato F., Gambari R., “Biosensor technology and surface plasmon resonance for real-time detection of HIV-1 genomic sequences amplified by polymerase chain reaction,” Clinical Diagnostic in Virology, Vol. 8, pp. 199-208 (1997); Jensen K. K., Orum H., Nielsen P. E., Norden B., “Kinetics for hybridization of peptide nucleic acids (PNA) with DNA and RNA studied with the BIAcore technique,” Biochemistry, Vol. 36, pp. 5072-5077 (1997); Malmqvist, M., “Biospecific interaction analysis using biosensor technology,” Nature, Vol. 361, pp. 186-187 (1993); Marshall, A., Hodgson, J., “DNA chips: an array of possibilities,” Nature Biotechnology, Vol. 16, pp. 27-31 (1998); Minunni, M., Tombelli, S., Mariottie, E., Mascini, M., “Biosensors as new analytic tool to detect Genetically Modified Organisms (GMOs),” Fresenius Journal of Analytic Chemistry, Vol. 369, pp. 589-593 (2001); and Persson B., Stenhag K., Nilsson P., Larsson A., Uhlen M., Nygren P., “Analysis of oligonucleotide probe affinities using surface plasmon resonance: a means for mutational scanning,” Analytical Biochemistry, Vol. 246, pp. 34-44 (1997).)

The detection limits of the highly sensitive interferometric devices are not believed to be as high has the SPR technique. The SPR technique is reportedly very sensitive, with a reported detection limit >10 pg/mm² mass loading (See, e.g., Karlsson, R. & Stahlberg, R., “Surface plasmon resonance detection and multispot sensing for direct monitoring of interactions involving low-molecular-weight analytes and for determination of low affinities,” Analytical Biochemistry, Vol. 228, pp. 274-280 (1995).) and allows real-time detection of bio-molecular interactions. The instrumentation, however, is of considerable size and the ability for multiplexed measurements is limited.

In view of the foregoing, there is a need for better DNA and/or RNA detection and quantification. Multiplexed DNA and/or RNA measurements are desirable. It is also desirable to miniaturize and integrate DNA/RNA measurement elements into portable, robust and easy to manufacture form. The ability to discriminate a single nucleotide mismatch is a desirable characteristic.

### § 2. SUMMARY OF THE INVENTION

The present invention provides improved DNA or RNA detection and/or quantification. The present invention may do so by exciting optical resonances in optical cavities (such as dielectric microspheres, for example), the surface of which includes oligonucleotides that can be hybridized with DNA or RNA. As DNA or RNA hybridization on the surface of an optical cavity occurs, the optical resonance of the cavity shifts, thereby indicating such hybridization.

In one embodiment of the present invention invention, DNA hybridization on a silica microsphere surface is quantified from the red-shift of an optical resonance wavelength. The present invention may use the fact that the fractional shift of a resonance wavelength δλ/λ may be expressed as αₑₓσₛ/[ε₀ (nₛ²−n_{b}²)R], where ε₀ is the vacuum permittivity, R is the microsphere radius (200 μm), nₛ (1.467) and n_{b} (1.332) are the refractive indices of the microsphere and the buffer solution, respectively. αₑₓ is the excess polarizability (the polarizability of a volume of DNA (or some other target nucleotide chain) in excess of an equal volume of water) and σₛ is the surface density of the bound DNA (or other target nucleotide chain). to determine the surface density of bound DNA target molecules.

In an embodiment of the present invention including multiple microspheres, each microsphere can be identified by its unique resonance wavelength. Thus, multiplexed DNA or RNA detection is possible.

At least some embodiments of the present invention can discriminate a single nucleotide mismatch in an N-mer (e.g., 11-mer) oligonucleotide.

### § 3. BRIEF DESCRIPTION OF THE DRAWINGS

FIG. 1 illustrates exemplary components of an exemplary system for detecting and/or quantifying DNA or RNA in a manner consistent with the present invention.

FIG. 2 illustrates how optical resonances (also referred to as “whispering gallery modes” or “WGMs”) from each microsphere of the system of FIG. 1 may be identified as Lorentzian dips in the transmission spectrum, and how a hybridization event of a complementary, label-free oligonucleotide on microsphere S1 may be manifested, and therefore detected, in real time (e.g., with millisecond time resolution), by an increase of the S1-specific resonance wavelength.

FIGS. 3A and 3B illustrate multiplexed DNA detection. FIG. 3A illustrates a transmission spectrum for one (dotted line) and two (solid line) microspheres, S1 and S2, coupled to the same optical fiber. FIG. 3B illustrates a time trace of the two resonance positions from S1 and S2.

FIG. 4 illustrates how salt concentration can affect the ability of the present invention to discriminate nucleotide mismatch.

FIGS. 5A and 5B illustrate the ability of the present invention to detect single nucleotide mismatch. FIG. 5A illustrates time traces of resonance wavelengths in two microspheres having surfaces immobilized with oligonucleotides that differ by a single nucleotide. FIG. 5B illustrates a difference signal which allows a single nucleotide mismatch to be identified with a high signal-to-noise ratio.

FIG. 6 is a side view of a multiple optical toroid sensor that is consistent with the present invention.

FIGS. 7 and 8 are plan views of alternative embodiments of a multiple optical toroid sensor that is consistent with the present invention.

FIG. 9 is a side view of a multiple microsphere sensor that is consistent with the present invention.

FIG. 10 is a flow diagram of an exemplary DNA or RNA measuring method that is consistent with the present invention.

### § 4. DETAILED DESCRIPTION

The following description of embodiments consistent with the principles of the present invention provides illustration and description, but is not intended to be exhaustive or to limit the present invention to the precise form disclosed. Modifications and variations are possible in light of the following teachings or may be acquired from practice of the present invention. For example, although a series of acts may have been described with reference to a flow diagram, the order of acts may differ in other implementations when the performance of one act is not dependent on the completion of another act. Further, non-dependent acts may be performed in parallel.

No element, act or instruction used in the description should be construed as critical or essential to the present invention unless explicitly described as such. Also, as used herein, the article “a” is intended to include one or more items. Where only one item is intended, the term “one” or similar language is used.

The present invention may detect and/or quantify DNA or RNA by observing a shift in the resonance of an optical cavity, such as microsphere for example, the surface of which has been treated with a complementary oligonucleotide with which the target DNA or RNA may hybridize.

### § 4.1 Exemplary Systems

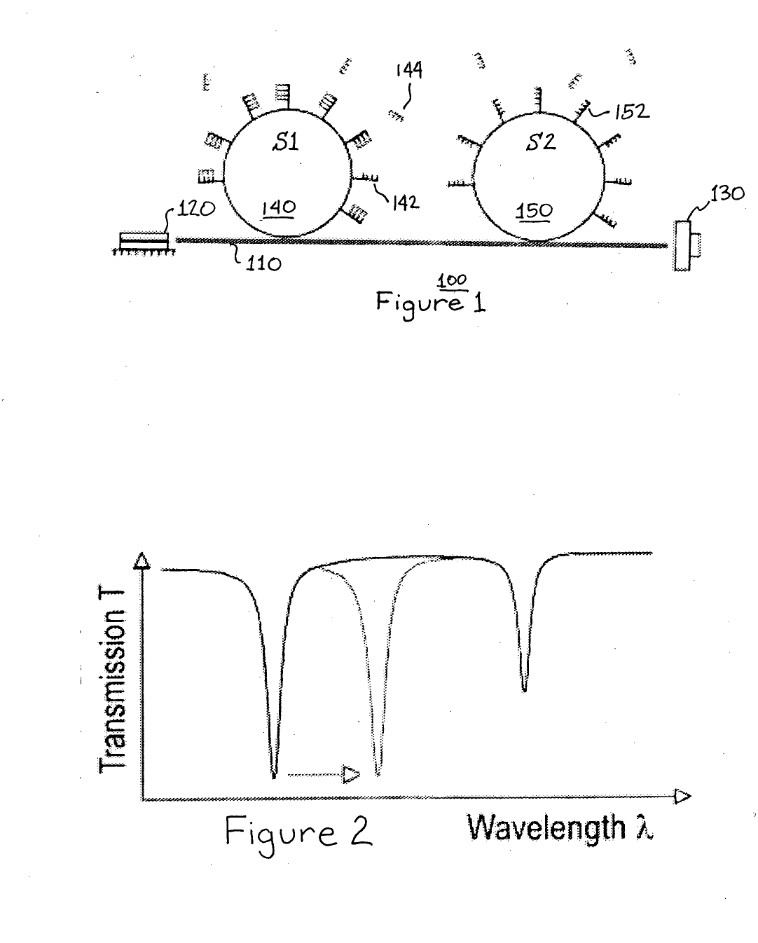

FIG. 1 illustrates exemplary components of an exemplary system 100 for detecting and/or quantifying DNA or RNA in a manner consistent with the present invention. Microspheres 140 and 150 are optically coupled with optical fiber 110. A light source 120 and a detector 130 are also optically coupled with the optical fiber 110. Oligonucleotides 142 which are complementary to target DNA 144 have been immobilized on the surface of microsphere 140. Oligonucleotides 152 which differ from those 142 immobilized on microsphere 140 may have been immobilized on the surface of the other microsphere 150.

The light source 120 may be a laser diode, such as a tunable, distributed feedback laser diode (e.g., 1312.8 nm nominal wavelength, 5 mW, ML776H11F from Mitsubishi of Japan). The optical fiber 110 may be a single mode optical fiber such as smf-28 optical fiber (e.g., from Canadian Instrumentation & Research Ltd. of Ontario, Canada). The detector may be an InGaAs photodetector (e.g., PDA400, from Thorlabs of Newton, N.J.). The microspheres 140,150 may be silica microspheres evanescently coupled to the fiber 110.

In an exemplary embodiment, light from source 120 is coupled into the optical fiber 110 (e.g., using a single mode fiber coupler such as F-1015LD from Newport of Irvine, Calif.). In one embodiment, to reduce back-reflections into the laser cavity, the optical fiber 110 ends in a glass capillary tube which is beveled at an angle of approximately 8 degrees. In one embodiment, the light source 120 is a laser diode and is held at constant temperature (e.g., using laser diode mount such as LDM-4407 from ILX Lightwave of Bozeman, Mont.). The photodetector 130 records the intensity of transmitted light for different wavelengths at the other end of the optical fiber 110. In one embodiment, the wavelength of an infrared laser 120 is scanned across a spectral width of only 0.14 nm by tuning the laser diode current (e.g., using a precision current source such as LDX-3525 from ILX Lightwave) with the sawtooth-shaped output of a function generator at 100 Hz (e.g., 33120A from Hewlett Packard). The tuning constant (e.g., 0.01 nm/mA) of the laser diode may be determined using a wavemeter (e.g., WA-1150 from Burleigh of Vanier, Canada). The spectrum may be digitally recorded (e.g., using a data acquisition card such as PCI-6036E from National Instruments of Austin, Tex.) at a resolution of 0.14×10⁻³ nm. A Labview program (from National Instruments) triggered by the TTL signal of the function generator may be used to control and display the data acquisition process. The Labview program may be used to localize the Lorentzian-dips in the intensity spectrum by a parabolic minimum fit using typically 11 points (which cover a spectral width of 1.5×10⁻³ nm).

Although not shown, one or more processors (e.g., in one or more computers) may be used to control the light source 120 and/or to process data from the light detector 130 in a manner consistent with the present invention.

FIG. 2 illustrates the shift in resonance wavelength of microsphere S1 after injection of DNA 144 and its hybridization with oligonucleotides 142 immobilized on the surface of S1 140. Notice that since the DNA 144 does not hybridize with the different oligonucleotides immobilized on the surface of S2 150, no shift in its resonance wavelength is observed.

The use of a microspheres to detect a substance, as well as fabrication of such microsphere-based detection systems and their components are described in: U.S. patent application Ser. No. 10/096,333 (referred to as “the '333 application” and incorporated herein by reference), titled “DETECTING AND/OR MEASURING A SUBSTANCE BASED ON A RESONANCE SHIFT OF PHOTONS ORBITING A MICROSPHERE,” filed on Feb. 12, 2002, and listing Stephen Arnold and Iwao Teraoka as inventors; U.S. patent application Ser. No. 10/690,979 (referred to as “the '979 application” and incorporated herein by reference), titled “ENHANCING THE SENSITIVITY OF A MICROSPHERE SENSOR,” filed on Oct. 22, 2003 and listing Stephen Arnold, Iwao Teraoka and Frank Vollmer as inventors; and U.S. patent application Ser. No. 10/735,247 (referred to as “the '247 application” and incorporated herein by reference), titled “USING A CHANGE IN ONE OR MORE PROPERTIES OF LIGHT IN ONE OR MORE MICROSPHERES FOR SENSING CHEMICALS USHC AS EXPLOSIVES AND POISON GASES,” filed on Dec. 12, 2003 and listing Stephen Arnold, Iwao Teraoka, Yoshiyuki Okamoto and Frank Vollmer as inventors. Each of the foregoing applications is incorporated herein by reference. As will be appreciated by those skilled in the art, various teachings from those applications can be used in concert with the present invention.

§ 4.1.1 Parts of Exemplary System and Exemplary Methods of Fabrication

§ 4.1.1.1 Fiber-Sphere Coupling

The microspheres may be coupled evanescently to the optical fiber. To access the evanescent field of the light traveling down the optical fiber, the polymer sheet of the fiber may be dissolved and removed (e.g., using methylenechloride). The bare silica fiber may then be cleaned (e.g., with 70% ethanol) before etching (e.g., in 25% hydrofluoric acid for ˜4½ hours). The etching process may be monitored (e.g., with a 20× microscope). The etching may be stopped (e.g., with NaHCO₃ solution) at an appropriate fiber diameter (e.g., as soon as the fiber diameter reaches 4 μm (the fiber core diameter is 6.6 μm)). The microspheres may be held in place with separate xyz-stages which allows them to be positioned in contact with the etched part of the optical fiber. (Note that although xyz-stages are useful in proof of concept experiments, some commercial implementations will not use such stages.) Coupling occurs as soon as the evanescent field of the fiber and microsphere overlap on mechanical contact. (If not mentioned otherwise, all chemicals may be purchased from Sigma-Aldrich of Milwaukee, Wis.)

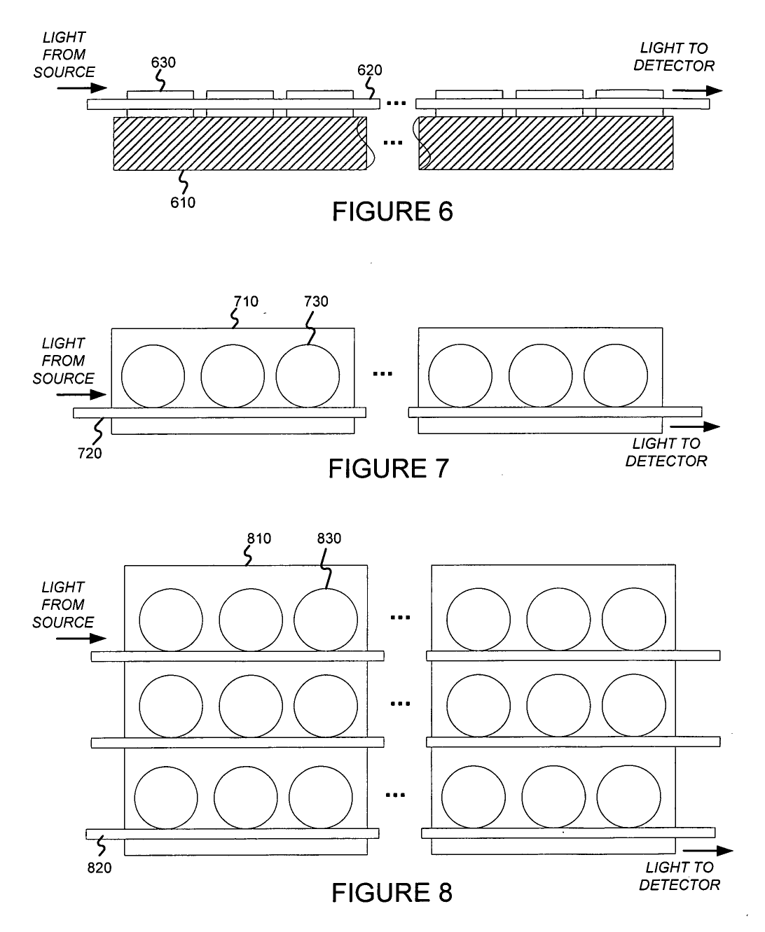

A large number of optical cavities can be provided on a single sensor. FIG. 6 is a side view of a multiple optical toroid sensor that is consistent with the present invention. A plurality of toroids 630 are provided on a substrate 610. One or more fibers 620 are optically coupled with the toroids 630 and may be coupled with a light source and a light detector (not shown). The fiber(s) 620 may be spaced above the substrate 610 as shown. Alternatively, the fibers 620 may be provided on, and supported by, the substrate 610. FIGS. 7 and 8 are plan views of alternative embodiments of a multiple-optical toroid sensor that is consistent with the present invention. In FIG. 7, multiple toroids 730 arranged in a line are supported by substrate 710, and are optically coupled with one or more fibers 720. In FIG. 8, multiple toroids 830 arranged in an array are supported by substrate 810, and are optically coupled with one or more fibers 820. If only one fiber 820 is provided, the ends may be optically coupled to wind back and forth through the array of toroids. If multiple fibers 820 are provided, they may be coupled with different detectors, particularly if the resonant wavelengths of the toroids are close and difficult to distinguish. For example, each fiber might only be optically coupled with two or three optical cavities in one exemplary embodiment. The multiple fibers 820 may be coupled with a single light source (although multiple light sources are possible). Although an array of toroids is shown, other two dimensional patterns (or even three dimensional patterns) are possible.

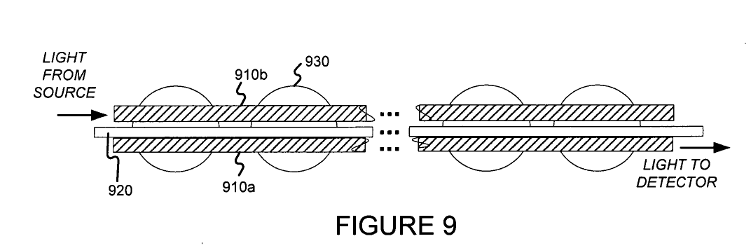

FIG. 9 is a side view of multiple-microsphere sensor that is consistent with the present invention. Two substrates 910a and 910b are provided with circular holes to accommodate microspheres 930. One or more optical fibers 920 may be optically coupled with the microspheres 930. The optical fiber(s) 920 may be mechanically coupled with the microspheres 930, mechanically supported by substrate 910a as shown, and/or sandwiched between substrates 910a and 910b. The microspheres 930 may be provided in a line, like the toroids of FIG. 7, or in a two dimensional array or pattern, like the toroids of FIG. 8, or even in a three dimensional array or pattern.

Other microsphere-to-fiber coupling techniques, such as known techniques and those described in the '333, '979 and '247 applications, may be used.

§ 4.1.1.2 Sphere Fabrication and Surface Modification

The microspheres (˜200 μm radius) may be fabricated by melting the tip of a stripped single mode near-infrared optical fiber (e.g., 125 μm diameter, FS-SC-6324 from Thorlabs). This melting may be done in a butane/nitrous oxide microtorch flame (e.g., from McMaster-Carr of Atlanta, Ga.). Surface tension forms the melted tip of the silica fiber into a spheroidal shaped object. The unmelted part of the fiber may be used as a stem for mounting the microsphere on an xyz-stage or some other mounting substrate. After melting, the microspheres may be cleaned immediately (e.g., using high-power oxygen plasma etching (e.g., plasma cleaner PDC-32G, Harrick, N.Y.) for 4 minutes). The present invention may use other microspheres, such as those described in the '333, '979 and '247 applications, as well as commercially available microspheres.

In one embodiment of the present invention, oligonucleotides may be provided on the surface of a microsphere as follows. A microsphere may be immersed in a (e.g., 4 μl) hanging drop of a dextran-biotin solution (e.g., 10 mg/ml from Sigma of St. Louis, Mo.) until dry, thus forming a dextran-biotin hydrogel on the surface of the microsphere. After a brief rinsing (e.g., in water for ˜5 minutes), the microsphere may then be incubated until dry (e.g., in a hanging drop of 4 μl of a 7 μM solution of biotinylated oligonucleotides (e.g., from Qiagen Operon of Alameda, Calif.), coupled to streptavidin (e.g., recombinant, E. coli, Sigma) at a molar ratio of 2:1). Microspheres produced in the foregoing way can be stored in the dry state for weeks. After brief dipping in water, the microspheres can be used immediately. Other oligonucleotides may be similarly immobilized. Such other oligonucleotides may be obtained from Qiagen Operon. The present invention may use other immobilization techniques, such as known immobilization techniques and those described in the '333, '979 and '247 applications.

### § 4.2 Exemplary Operations and Characteristics or Properties of Exemplary Systems

§ 4.2.1 Analytic Theory

An analytic theory may be used to describe the shift of a WGM due to binding of polarizable molecules to the surface of the microsphere. For the binding of DNA to a microsphere surface, the fractional shift of a resonance wavelength δλ/λ may be expressed as αₑₓσₛ/[ε₀ (nₛ²−n_{b}²)R], where ε₀ is the vacuum permittivity, R is the microsphere radius (200 μm), nₛ (1.467) and n_{b} (1.332) are the refractive indices of the microsphere and the buffer solution, respectively. αₑₓ is the excess polarizability (the polarizability of a volume of DNA in excess of an equal volume of water) and σₛ is the surface density of the bound DNA.

The fractional shift in wavelength for a single DNA molecule binding on the surface of the sphere directly above the resonant light orbit may be calculated as (δλ/λ)ₛ=αₑₓ|Y/²/[ε₀ (nₛ²−n_{b}²)R³], where Y is the spherical harmonic function describing the light orbit.

§ 4.2.2 Experimental Setup for Multiplexed DNA Detection

In one embodiment of the present invention, at least two microspheres are coupled with the optical fiber. The microspheres may be coupled to the fiber sequentially, one at a time, or in parallel. The microspheres may be held in place by separate xyz-stages which allowed independent coupling to the optical fiber. No cross coupling between the WGMs of two microspheres, located on the fiber several micrometers apart, was observed.

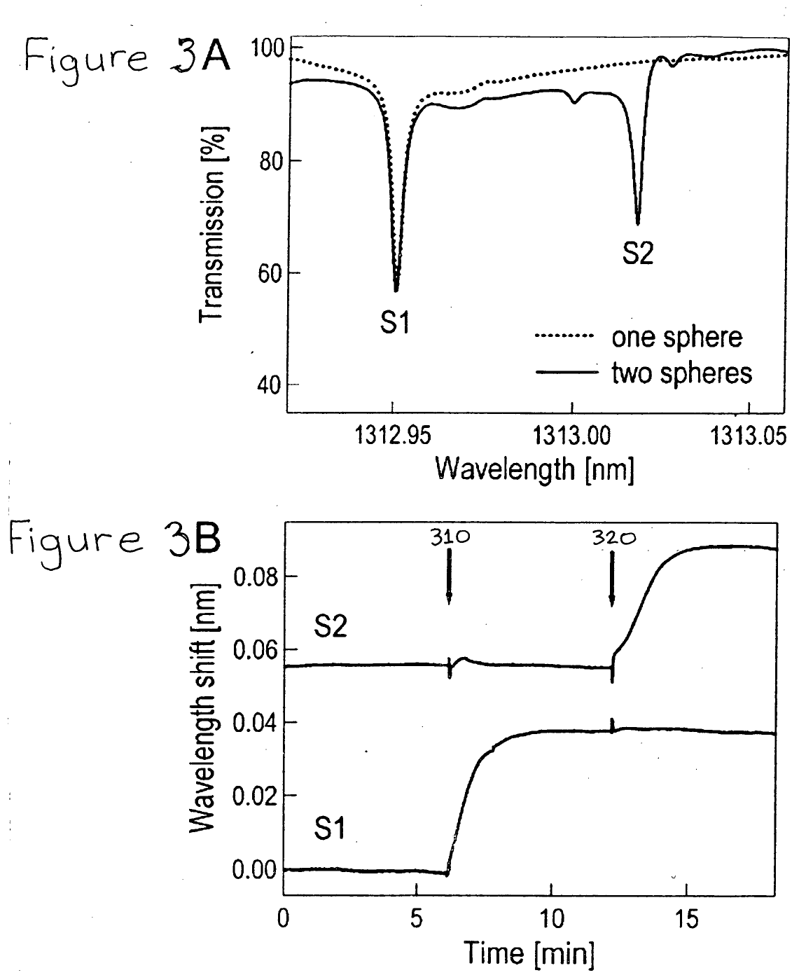

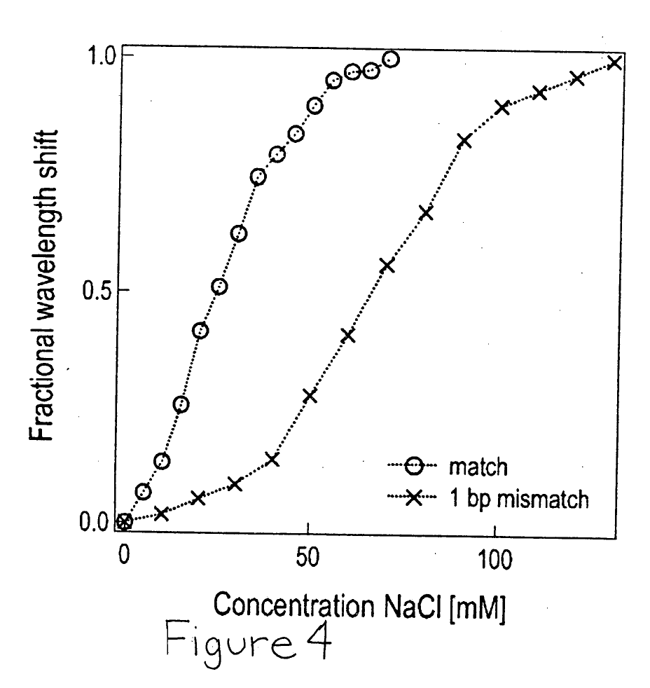

FIG. 3A illustrates transmission spectrum for one (dotted line) and two (solid line) microspheres coupled to the same optical fiber, immersed in a PBS solution at room temperature. Both microspheres are ˜200 μm in radius. The narrow infrared spectrum ranging from 1312.92 to 1313.06 nm is recorded every 10 ms. The position of the resonance wavelengths from each of the microspheres S1 and S2 is located by a parabolic minimum fit in a resolution of ˜ 1/50 of the linewidth, allowing detection of a fractional wavelength change δλ/λ as small as ˜3×10⁻⁷. Both spheres were modified with unrelated, 27-mer oligonucleotides. Specifically, microsphere S1 was modified with 5′-biotin-TATGAATTCAATCCGTCGAGCAGAGTT, and microsphere S2 was modified with 5′-biotin-ATTAATACGACTCACTATAGGGCGATG.

As shown in FIG. 3A, each microsphere essentially removes energy independently from the optical fiber at its resonant wavelength. Coupling strengths may vary 30-70%. This variation in coupling strengths may result in different amplitudes of the resonance dips, such as those illustrated in FIG. 3A. Coupling two microspheres to the fiber sequentially allows resonances corresponding to each individual sphere to be unambiguously identified. A parabolic minimum fit may be used to determine the resonance position at the minimum in the transmission signal. With this detection scheme, the position of a resonance with a precision of almost two orders of magnitude higher than given by the linewidth may be determined.

Experiments were performed in a liquid sample cell (See, e.g., Vollmer, F., Braun, D., Libchaber, A., Khoshsima, M., Teraoka, I. & Arnold, S., “Protein detection by optical shift of a resonant microcavity,” Applied Physics Letters, Vol. 80, pp. 4057-4059 (2002).) containing two silica spheres immersed in a buffer solution and evanescently coupled to the same single mode, near-infrared optical fiber. (See, e.g., the system 100 of FIG. 1.)

Infrared light from tunable laser source was coupled into one end of the fiber. A photodetector recorded the intensity of transmitted light for different wavelengths at the other fiber end. The resonances from each sphere are separated by several linewidths, which makes it possible to identify them independently as Lorentzian-shaped dips in the spectrum of the transmitted light. Recall from FIG. 2, for example, that optical resonances (WGMs) from each microsphere may be identified as Lorentzian dips in the transmission spectrum. Each microsphere S1 and S2 may be modified with a different oligonucleotide of interest. The hybridization event of the complementary, label-free oligonucleotide on microsphere S1 is detected in real time with millisecond time resolution by an increase of the S1-specific resonance wavelength. This leads to a shift of the S1-specific resonance position.

Oligonucleotides of different sequences were immobilized to the surface of each sphere. The binding of the unlabeled complementary oligonucleotide to its surface-immobilized counterpart was measured in real time from a red-shift of the sphere-specific WGM resonance. The single strand DNA diffuses to the surface of the microsphere where it hybridizes to its complement. Close to the surface of the microsphere, the oligonucleotide interacts with the evanescent field of the WGM which extends about a wavelength into the buffer solution. This interaction polarizes the molecule and thus increases the resonance wavelength of the mode.

§ 4.2.3 High-Sensitivity DNA Detection

The transduction of a specific hybridization event into an increase of a corresponding resonance wavelength in a measurement with two microspheres S1 and S2, each modified with a different 27-mer oligonucleotide, was demonstrated. In the sample cell, the two microspheres were equilibrated at room temperature in phosphate buffered saline (PBS, pH 7.4) until the resonance positions became stable and displayed no drifts. This is illustrated in FIG. 3B to the left of arrow 310. Then, at a time indicated by the arrow 310, the oligonucleotide complementary to the one immobilized on microsphere S1 was injected into the sample cell. As indicated by the arrow 320, this was followed minutes later by the injection of the oligonucleotide complementary to the DNA strand immobilized on sphere S2. The injected oligonucleotides diffused to the surfaces of the respective microspheres and hybridized to their surface-bound target strands. The time trace of the two sphere-specific resonance positions of FIG. 3B illustrates the two independent hybridization events. First, after injection of the complementary oligonucleotide (arrow 310), the resonance wavelength of the corresponding microsphere S1 showed a large increase. There was no detectable unspecific hybridization in this experiment. That is, one injected oligonucleotide increased only the resonance wavelength of the corresponding microsphere S1 while the resonance wavelength of the other microsphere S2 remained unchanged. The two complementary DNA oligonucleotides were injected into the sample solution to a final concentration of 1 μM each. Hybridization saturated within minutes and the resonance wavelength of the corresponding microsphere increased about 0.038 nm each. The noise before adding the complementary DNA was only ˜0.04×10⁻³ nm. Note that in FIG. 3B, the graphed characteristic of microsphere S2 was moved up to separate it from that of microsphere S1 in order to simplify the drawing.

The oligonucleotides were injected to a final concentration of 1 μM. Despite the rather large background concentration, the sequential injection of the second oligonucleotide produced a similar resonance wavelength shift as compared to the first injected oligonucleotide.

Note that the spikes in the wavelength shifts shortly after the injections are believed to be due to temperature and refractive index fluctuations in the surrounding media caused by turbulences after mixing with a hypodermic needle.

For the hybridization of the complementary 27-mer oligonucleotide to the surface of microsphere S1, a wavelength shift of ˜0.038 nm was observed. Using the analytic theory relating the wavelength shift of a WGM in a microsphere to the surface density of bound molecules introduced in § 4.2.1 above, the surface density of hybridized oligonucleotides can be determined or estimated. For the 27-mer oligonucleotide with the excess polarizability of 4πε₀×4.8×10⁻²² cm³, the surface density of hybridized oligonucleotides is determined as 3.6×10¹³ oligonucleotide targets/cm² using the analytic theory and the observed wavelength shift.

Although the sphere surfaces were modified with a dextran hydrogel, the Q-factors of the WGMs were still on the order of 5×10⁵ and largely limited by overtone vibrational absorption of water near 1.3 μm. Given this high Q factor, a microsphere diameter of 200 μm and a noise level which allows wavelength shifts with a precision of 1/50 of the linewidth to be determined, the limit of the measurement technique of this exemplary embodiment is believe to be ˜6 pg/mm² nucleic acid mass loading.

In this exemplary embodiment, the microspheres were modified with a dextran hydrogel. The biotinylated dextran forms a three-dimensional matrix on the surface of the microsphere. Every dextran molecule was modified with ˜7 biotin groups to increase the surface density by several layers of streptavidin binding sites. The 27-mer oligonucleotide probes were immobilized on the biotin-dextran hydrogel as a streptavidin-DNA complex. Each streptavidin molecule was bound to two biotinylated, 27-mer oligonucleotides. A wavelength shift of 0.255 nm was measured for the binding of the streptavidin-DNA complex to the surface immobilized, biotinylated dextran-hydrogel. With the excess polarizabilitiy of 4πε₀×4.3×10⁻²¹ cm³ for the streptavidin-DNA complex, the density of immobilized oligonucleotide probes was estimated as 4.6×10¹³ oligonucleotide probes/cm². By taking the ratio of the measured surface densities for the hybridized target strands and for the immobilized DNA probes, note that 78% (=3.6×10¹³/4.6×10¹³) of the immobilized single stranded DNA is accessible for hybridization.

§ 4.2.4 Single Nucleotide Mismatch Detection

Discrimination of a single nucleotide mismatch is a useful, and in many cases an important, analytic ability of any DNA or RNA sensor. Detection of the mismatch is optimal at a specific temperature and salt concentration, which depends on the length of the oligonucleotide. The optimal temperature and/or salt concentration can be determined experimentally.

At a given temperature, the salt concentration can be varied to determine this optimal salt concentration for the given temperature. FIG. 4 illustrates the melting curves for match and mismatch hybridization of an 11-mer oligonucleotide (5′-biotin-CTATCTCAGTC) on a single microsphere as the salt concentration is varied. Equilibrium resonance wavelength shifts were recorded after hybridization to the perfect match and to the 1 base pair (bp, a single nucleotide) mismatch sequence (3′-GATATAGTCAG) at different NaCl concentrations. It was determined that the hybridization signal from the matching sequence can be nearly ten times as large as the one from the mismatching sequence when the exemplary system is used in a 20 mM Tris buffer (pH 7.8) containing 30 mM NaCl at room temperature (˜23° C.)

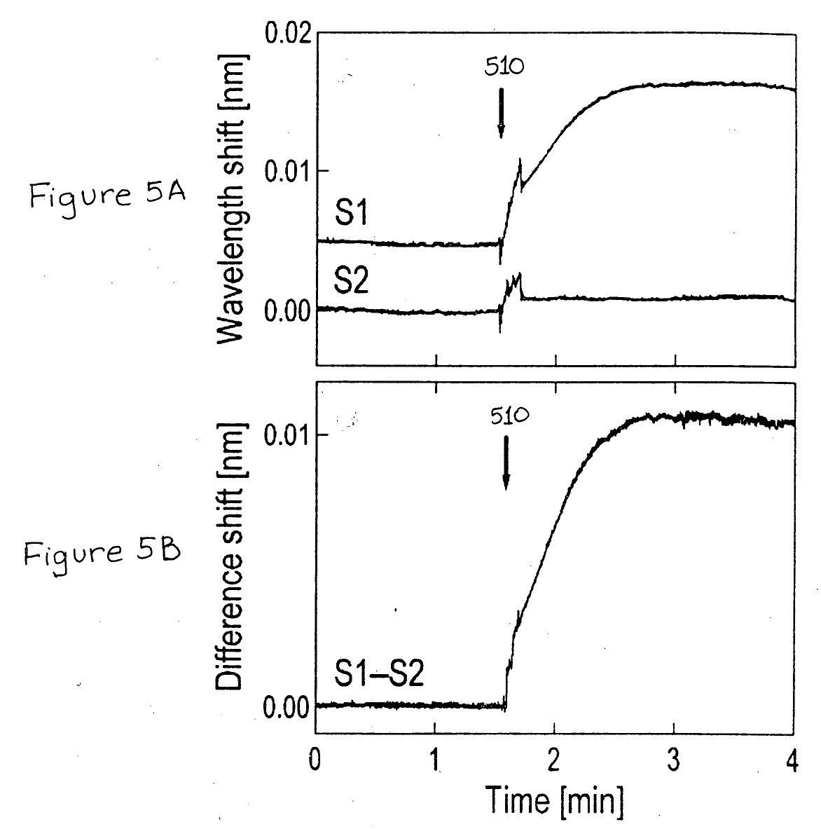

The optimized temperature and salt concentration conditions determined experimentally were then used in a measurement with two microspheres. The first microsphere S1 was modified with the perfectly matching biotinylated 11-mer oligonucleotide sequence (5′-biotin-CTATCTCAGTC), while the second microsphere S2 carried the single nucleotide mismatch sequence (5′-biotin-CTATATCAGTC). FIG. 5A shows a trace of the two resonances of the microspheres S1 and S2 over time. After temperature equilibration stabilized the traces, an 11-mer DNA strand was injected (to a final concentration of 1 μM) into the sample (See, arrow 510 at about 90 seconds) with a sequence which was complementary to the oligonucleotide immobilized on microsphere S1. As shown in FIG. 5A, hybridization to the perfect match oligonucleotide on microsphere S1 produced a much larger increase in resonance wavelength than the hybridization to the oligonucleotide with the single nucleotide mismatch on microsphere S2. Specifically, hybridization to the single mismatched sequence on microsphere S2 produced 1/10 of the increase, consistent with the hybridization data obtained in the single-sphere experiments using the same experimental conditions. FIG. 5B is a plot of the difference signal which shows unambiguous identification of a single nucleotide mismatch with a high signal-to-noise ratio of 54 (where signal-to-noise ratio is calculated by dividing the wavelength shift of the difference signal after hybridization by the noise before hybridization). Note that the initial disturbances in the single traces (believed to be due to temperature and refractive index fluctuations in the surrounding media caused by turbulences after mixing with a hypodermic needle) are largely removed in the difference plot. Note that in FIG. 5A, the graphed characteristic of microsphere S1 was moved up to separate it from that of microsphere S2 in order to simplify the drawing.

### § 4.3 Methods

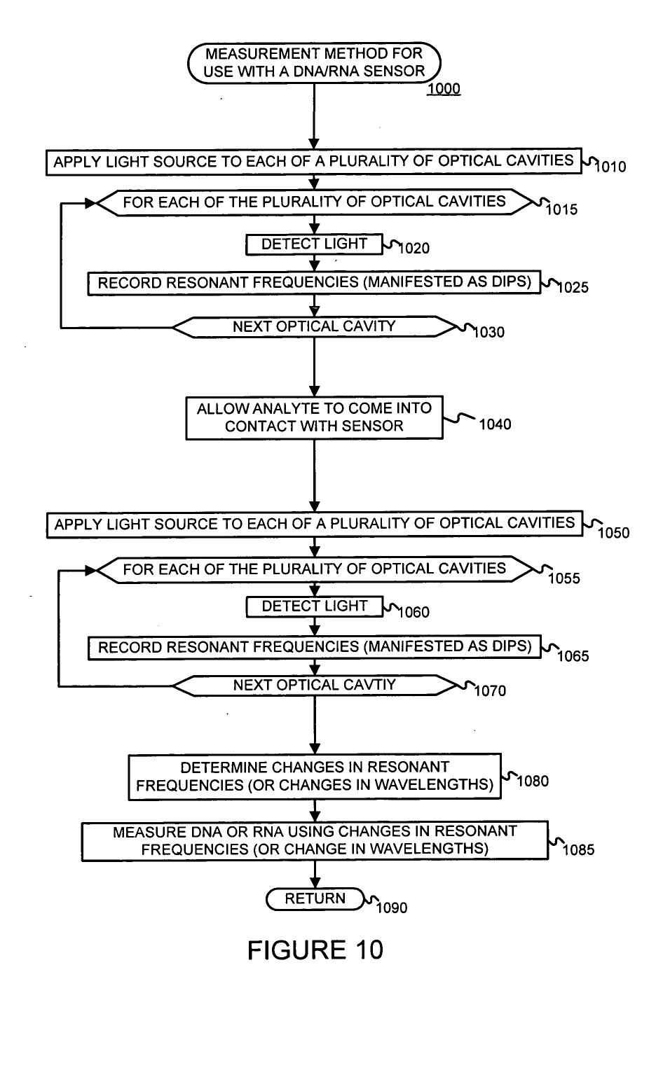

FIG. 10 is a flow diagram of an exemplary DNA or RNA measuring method 100 that is consistent with the present invention. A light source is applied to each of a plurality of optical cavities. (Block 810) As indicated by loop 1015-1030 for each of the plurality of optical cavities, light is detected (Block 1020), and one or more resonance characteristics (e.g., frequency, wavelength) are recorded (Block 1025). Analyte is then permitted to come into contact with the sensor. (Block 1040)

The light source is applied (or continues to be applied) to each of a plurality of optical cavities. (Block 1050) As indicated by loop 1055-1070, for each of the plurality of optical cavities, light is (or continues to be) detected (Block 1060), and one or more resonance characteristic(s) are recorded (Block 1065). Changes in the resonance characteristic(s) are determined. (Block 1080) DNA or RNA in the analyte may then be measured using the changes in resonance characteristic(s) determined. (Block 1085) Although not shown, a difference in the resonance shifts of two of the optical cavities may be used to measure the DNA or RNA.

### § 4.4 Alternatives and Refinements

Although the exemplary embodiments of the present invention described above had 11-mer or 27-mer oligonucleotides immobilized on the surfaces of microspheres, the present invention may be practiced with longer or shorter oligonucleotides. Generally, the present invention can be practiced with N-mer oligonucleotides, where N is an integer. In some embodiments of the present invention, N may range from 2 to 50. It is best if the target DNA or RNA sought to be measured is equal to or shorter than the oligonucleotide immobilized on the surface of the optical cavity.

Although the present invention was described with reference to particular microspheres having a particular size and formed of a particular material, the present invention may be practiced with microspheres of different sizes and/or materials, such as those described in the '333, '979, and '247 applications. The use of smaller microspheres or toroidal shaped particles may be used to increase the distance between adjacent resonance wavelengths. (See, e.g., Ilchenko, V. S., Gorodetsky, M. L., Yao, X. S. & Maleki, L., “Microtorus: a high-finesse microcavity with whispering-gallery modes,” Optics Letters, Vol. 26, pp. 256-258 (2001).) Therefore coupling many microspheres or other optical cavities to one or more waveguides in an array type sensor can be realized. The silica microspheres can be replaced by silicon (See, e.g., Krioukov, E., Klunder, D. J. W., Driessen, A., Greve, J., Otto, C., “Sensor based on an integrated optical microcavity,” Optics Letters, Vol. 27, pp. 512-514 (2002); and Krioukov, E., Klunder, D. J. W., Driessen, A., Greve, J., Otto, C., “Integrated optical microcavities for enhanced evanescent-wave spectroscopy,” Optics Letters, Vol. 27, pp. 1504-1506 (2002).), InP microdiscs (See, e.g., Djordjev, K., Choi, S. J., Dapkus, “P.D.CH₄-based dry etching of high Q InP microdisks,” Journal of Vacuum Science Technology B, Vol. 20, pp. 301-305 (2002).) or ultra-high-Q toroid microcavities (See, e.g., Armani, D. K., Kippenberg, T. J., Spillane, S. M., Vahala, K. J., “Ultra-high-Q toroid microcavity on a chip,” Nature, Vol. 421, pp. 925-928 (2003)), thus allowing miniaturization into an integrated semiconductor device. Thus, the present invention may be implemented as a compact, portable, biosensor with spot dimensions on the order of a few micrometers.

Although the exemplary embodiments described above included two microspheres having surfaces on which two different oligonucleotides are immobilized, more than two microspheres, or some other optical cavities, may be used.

Although the exemplary embodiments illustrated the detection of DNA, other substances including a chain (i.e., one or more chains) of nucleotides, such as RNA for example, may be detected and/or quantified using the present invention.

Several measurement platforms (e.g., optical cavities having surfaces on which particular oligonucleotides are immobilized) could be connected to a network (e.g., by end-to-end coupling of the optical fiber) to construct a distributed sensor. Such a distributed sensor could easily cover a large sensing area. For example, a distributed sensor could be used to sense RNA and/or DNA around the circumference of a lake.

### § 4.5 Conclusions

As can be appreciated from the foregoing, the present invention advantageously enables label-free, high-sensitivity DNA or RNA quantification. The present invention enables multiplexed measurements on a simple platform. As compared to existing optical biosensors (such as SPR biosensors) where the light is passed through the sample only once, the present invention exploits optical resonances for quantitative DNA measurements. These optical resonances allow the light to interact with an analyte molecule several thousand times, thus increasing the ultimate detection limit by several orders of magnitude as compared to single-pass techniques. Indeed, the present invention demonstrates a sensitivity which is greater than that of commercially available SPR devices. For example, in one exemplary embodiment of the present invention, a mass loading of only ˜6 pg/mm² of polarizable DNA material on the microsphere surface lead to a detectable spectroscopic shift of the resonance. The sensitivity is higher as compared to the reported sensitivities of commercially available SPR biosensing devices (e.g., >10 pg/mm², corresponding to 10 response units in a Biacore instrument). Finally, the present invention permits even single nucleotide mismatch detection.

Difference measurements with the two microspheres allow the removal of common mode noise. The increase of resonance wavelength in one of the microspheres can be compared to the other microsphere interacting with the same sample analyte but lacking a specific biological factor of interest. For molecular interaction studies, the first microsphere could be modified with the recognition element, whereas the second microsphere is not modified. The difference signal eliminates most of the noise due to unspecific binding, temperature and refractive index fluctuations that may occur (e.g. after injection). Thermal drifts are intrinsically eliminated because the change in resonance wavelength due to thermal expansion/contraction is independent of the microsphere size.

Multiple optical cavities, each having a different oligonucleotide immobilized on its surface, may be provided, as an analytic component, on a single portable article. Thus, the present invention enables DNA lab-on-a-chip form factors.

What is claimed is:

1. For use in a system including a light source, and a light detector, for measuring one or more of at least two target substances, each of the at least two target substances including a chain of nucleotides, a sensor comprising:
a) at least one optical carrier;
b) at least two optical cavities, each of the at least two optical cavities
1) being optically coupled with the optical carrier, and
2) having a surface including oligonucleotides complementary to a particular one of the at least two target substances,
wherein, when light is applied to the optical carrier, a resonance within each of the optical cavities is excited,
wherein, if a target substance hybridizes with oligonucleotides on the surface of an optical cavity, a shift in the resonance of that optical cavity occurs, and
wherein a measurement of the target substance can be determined based on the shift in resonance.

2. The sensor of claim 1 wherein the optical carrier is an optical fiber.

3. The sensor of claim 1 wherein at least one of the optical cavities is a microsphere.

4. The sensor of claim 1 wherein at least one of the optical cavities is a toroidal microcavity.

5. The sensor of claim 1 wherein at least one of the optical cavities is a InP microdisk.

6. The sensor of claim 1 wherein at least one of the target substances is DNA

7. The sensor of claim 1 wherein at least one of the target substances is RNA

8. The sensor of claim 1 wherein, if a target substance hybridizes with oligonucleotides on the surface of an optical cavity surface, a shift in the resonance of that optical cavity of a first amount occurs, and
wherein if a substance which differs from the target substance by a single nucleotide is made available for hybridization with the surface of the optical cavity surface, a shift in the resonance of the optical cavity of a second amount occurs, wherein the first amount is detectably greater than the second amount.

9. The sensor of claim 8 wherein the first amount is at least ten times greater than the second amount.

10. The sensor of claim 1 wherein the oligonucleotides provided on at least one of the optical cavities are 11-mer oligonucleotides.

11. The sensor of claim 1 wherein the oligonucleotides provided on at least one of the optical cavities are at least 27-mer oligonucleotides.

12. The sensor of claim 1 wherein the oligonucleotides provided on at least one of the optical cavities are at least 11-mer oligonucleotides.

13. The sensor of claim 1 wherein the oligonucleotides provided on at least one of the optical cavities are at most 27-mer oligonucleotides.

14. A system for measuring one or more of at least two target substances, each of the at least two target substances including a chain of nucleotides, the system comprising:
a) a light source;
b) a light detector;
c) a sensor, the sensor including
1) at least one optical carrier optically coupled with both the light source and the light detector;
2) at least two optical cavities, each of the at least two optical cavities
A) being optically coupled with the optical carrier, and
B) having a surface including oligonucleotides complementary to a particular one of the at least two target substances,
wherein, when the light source applies light to the optical carrier, a resonance within each of the optical cavities, having a first characteristic, is excited and is detected by the detector, and
wherein, if a target substance hybridizes with oligonucleotides on the surface of an optical cavity, a change in the characteristic of the resonance of that optical cavity occurs and is detected by the detector; and
d) a processor for determining a measurement of the target substance using a shift in the characteristic of the resonances detected by the detector.

15. The system of claim 14 wherein the optical carrier is an optical fiber.

16. The system of claim 14 wherein at least one of the optical cavities is a microsphere.

17. The system of claim 14 wherein at least one of the optical cavities is a toroidal microcavity.

18. The system of claim 14 wherein at least one of the optical cavities is a InP microdisk.

19. The system of claim 14 wherein at least one of the target substances is DNA

20. The system of claim 14 wherein at least one of the target substances is RNA

21. The system of claim 14 wherein, if a target substance hybridizes with oligonucleotides on the surface of an optical cavity surface, a shift in the resonance of that optical cavity of a first amount occurs, and
wherein if a substance which differs from the target substance by a single nucleotide is made available for hybridization with the surface of the optical cavity surface, a shift in the resonance of the optical cavity of a second amount occurs, wherein the first amount is detectably greater than the second amount.

22. The system of claim 21 wherein the first amount is at least ten times greater than the second amount.

23. The system of claim 14 wherein the oligonucleotides provided on at least one of the optical cavities are 11-mer oligonucleotides.

24. The system of claim 14 wherein the oligonucleotides provided on at least one of the optical cavities are at least 27-mer oligonucleotides.

25. The system of claim 14 wherein the oligonucleotides provided on at least one of the optical cavities are at least 11-mer oligonucleotides.

26. The system of claim 14 wherein the oligonucleotides provided on at least one of the optical cavities are at most 27-mer oligonucleotides.

27. The system of claim 14 wherein the processor determines the measurement of the target substance using a shift in characteristic of the resonances detected by the detector, and refractive indices of the optical cavity and a solution in which the target substance is allowed to come into contact with the optical cavity.

28. The system of claim 27 wherein the processor determines the measurement of the target substance further using an excess polarizability of a volume of the target over an equal volume of a solution in which the target is provided.

29. The system of claim 14, wherein the optical cavity is a microsphere, and
wherein the processor determines the measurement of the target substance using a shift in characteristic of the resonances detected by the detector, and a radius of the microsphere.

30. The system of claim 14 wherein the measurement of the target substance is a surface density of the target substance bound to the optical cavity.

31. The system of claim 14 wherein the at least one optical carrier includes a plurality of optical fibers.

32. The system of claim 31 wherein each of the plurality of optical fibers is optically coupled with at least two of the optical cavities.

33. The system of claim 31 further comprising at least one additional light detector,
wherein at least two of the plurality of optical fibers are optically coupled with a common light source, but with different light detectors.

34. A method for measuring one or more of at least two target substances, each of the at least two target substances including a chain of nucleotides, using a system including, a light source, a light detector, and a sensor, the sensor including at least one optical carrier optically coupled with both the light source and the light detector and at least two optical cavities, each of the at least two optical cavities being optically coupled with the optical carrier, and having a surface including oligonucleotides complementary to a particular one of the at least two target substances, the method comprising:
a) applying light, using the light source, to the optical carrier;
b) detecting, with the detector, at a first time, a characteristic of a resonance excited within each of the optical cavities, having a characteristic;
c) providing a solution which may include one or more of the target substances in fluid contact with the sensor;
d) detecting, with the detector, at a second time, a change in the characteristic of the resonance of any of the optical cavities; and
e) determining a measurement of the target substance using a shift in characteristic of the resonances detected by the detector.

35. The method of claim 34 wherein at least one of the target substances is DNA

36. The method of claim 34 wherein at least one of the target substances is RNA

37. A method for measuring one or more of at least two target substances, each of the at least two target substances including a chain of nucleotides, using a system including, a light source, a light detector, and a sensor, the sensor including at least one optical carrier optically coupled with both the light source and the light detector and at least two optical cavities, each of the at least two optical cavities being optically coupled with the optical carrier, and having a surface including oligonucleotides complementary to a particular one of the at least two target substances, the method comprising:
a) applying light, using the light source, to the optical carrier;
b) detecting, with the detector, at a first time, a resonance excited within each of the optical cavities, having a characteristic;
c) applying a solution which may include one or more of the target substances in fluid contact with the sensor;
d) detecting, with the detector, at a second time, a change in the characteristic of the resonance of two of the optical cavities;
e) determining, for each of the two of the optical cavities, a shift in the characteristic of the resonances detected by the detector; and
f) determining a measurement of the target substance using a difference of the shifts in characteristic of the resonances detected by the detector.

38. The method of claim 37 wherein at least one of the target substances is DNA

39. The method of claim 37 wherein at least one of the target substances is RNA
